(19) United States
(12) Patent Application Publication
(10) Pub. No.: US 2003/0076034 A1
(43) Pub. Date: Apr. 24, 2003

(54) Led chip package with four led chips and intergrated optics for collimating and mixing the light

(76) Inventors: Thomas M. Marshall, Hartsdale, NY (US); Frank Jeroen Pieter Schuurmans, Valkenswaard (NL); Douglas Peter Woolverton, Mountain View, CA (US); Michael David Pashley, Cortlandt Manor, NY (US)

Correspondence Address: Corporate Patent Counsel, Philips Electronics North America Corporation, 580 White Plains Road, Tarrytown, NY, 10591, US

(21) Appl. No.: 10/083,328

(22) Filed: Oct. 22, 2001

(51) Int. Cl. H05B 33/00

(52) U.S. Cl. 313/512

(57) ABSTRACT

A LED chip package including a base, an array of LED chips disposed on the base, and a collimator mounted on the base, over the array of light-emitting-diode chips. The LED chips of the array are typically arranged in an inline manner. The collimator is generally configured as a rectangular, horn-like member and typically includes a first set of walls that collimate the light emitted by the LED chips in a first direction and a second set of walls that minimally collimate the light emitted by the LED chips in a second direction.

### FIELD OF THE INVENTION

The present invention relates to light-emitting-diode (LED) array-type light sources, and more particularly, to a multi-LED chip package having LED chips arranged in a linear array on a common base, and a collimator that facilitates efficient LED light collimation and strongly enhances color mixing.

### BACKGROUND OF THE INVENTION

Present light-emitting-diode (LED) chip packages contain one LED chip per package, and have relatively simple optics on the package itself that necessitates a secondary optics system to provide any needed collimation or other beam shaping. For example, the Prometheus package marketed by LumiLeds includes one chip mounted on a planar slug and a simple hemispheric dome lens that provides approximately a Lambertian emission pattern into a full 2π of solid angle. In another example, the Barracuda package marketed by LumiLeds includes one chip in a reflector cup and a nonspherical lens that provides a shaped emission pattern. Such packages produce a broad angular distribution (at least 60° cone angle) of light. The use of individual RGB LED packages requires all color mixing to be external to the package. Since the individual packaging forces a large distance (>8 mm in the case of the LumiLeds high flux packages) between chips, the color mixing is made more difficult than if the chips could be placed closer together. Generally, in the design of any application seeking to make white light from the LED chips (red, green, and blue LEDs for example) one needs to address the trade-off between color mixing and overall optical efficiency.

In display applications, such as backlights for LCD monitors or televisions, the LED light is injected directly into one or more edges of a slab light guide. The dimensions of that edge are typically about 5-10 mm in thickness by about 100-400 mm in width, depending on the specific display. In such applications, it is desirable to collimate the LED light in the smaller thickness dimension, but it is also desirable, from a color mixing standpoint, to broadly distribute the light in the larger width dimension. It is also well established that color mixing is improved by reducing the spacing between separate colors.

Accordingly, an LED chip package with improved collimation and color mixing is needed.

### SUMMARY OF THE INVENTION

An LED chip package comprising a base, an array of LED chips disposed on the base, and a collimator mounted on the base, over the array of light-emitting-diode chips. The LED chips of the array are typically arranged in an inline manner.

In one aspect of the invention, the collimator is generally configured as a rectangular, horn-like member. The collimator typically includes a first set of walls that collimate the light emitted by the LED chips in a first direction and a second set of walls that minimally collimate the light emitted by the LED chips in a second direction.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a transverse sectional view of an LED chip package according to an exemplary embodiment of the present invention;

FIG. 2 is a longitudinal sectional view of the LED chip package of FIG. 1; and

FIGS. 3A-3C are top plan views of light sources constructed with LED chip packages of the present invention.

### DETAILED DESCRIPTION

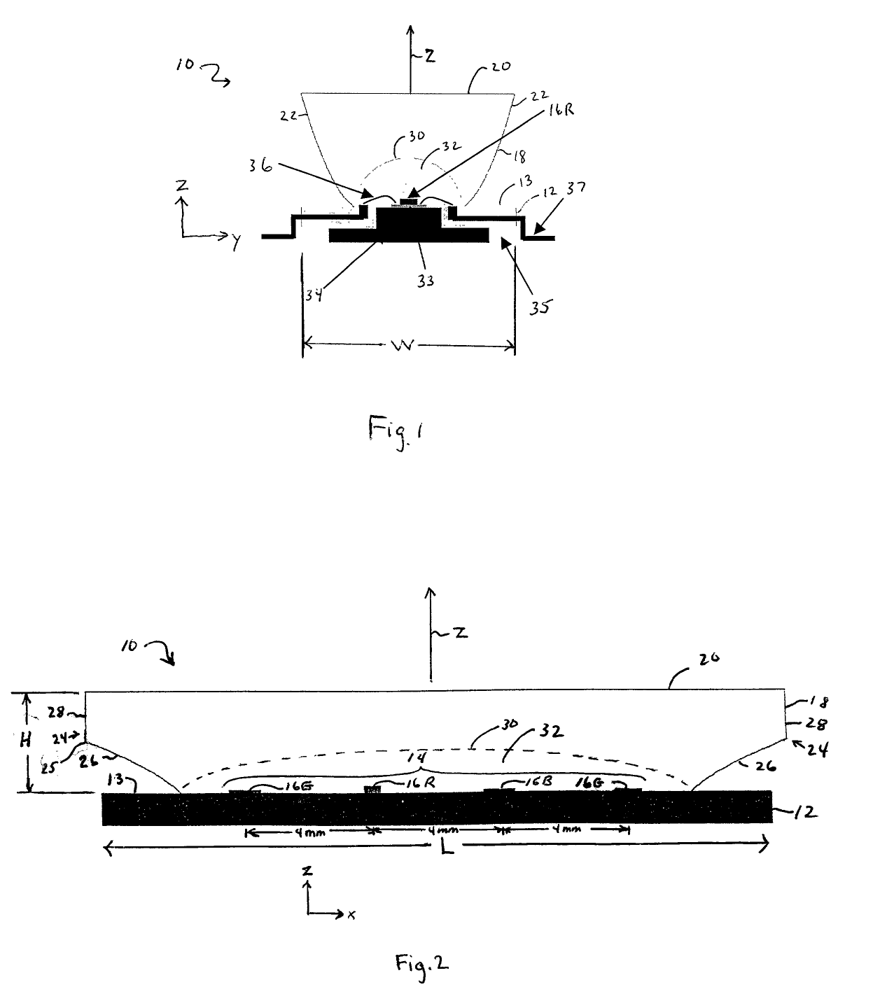

FIGS. 1 and 2 collectively show an LED chip package 10 according to an exemplary embodiment of the present invention. The LED chip package 10 includes multiple colored LED chips 16G, 16R, 16B arranged in a linear array 14 on a single elongated base 12, which may include provisions for bonding lead wires (not shown), and a collimator 18 integrally mounted over the LED chips 16G, 16R, 16B on the base 12. The LED chip package of the present invention produces a single “unit” of white light from the array 14 of multiple colored LED chips 16G, 16R, 16B. As one of ordinary skill in the art will soon appreciate, the LED chip package 10 of the present invention can be freely adapted to provide a desired angular emission pattern with excellent color mixing.

The LED chips 16G, 16R, 16B of the linear array 14 may comprise conventional green, red, and blue LED chips that respectively emit green, red, and blue light. Such LED chips facilitate efficient injection into an LCD backlight light guide and strongly enhance color mixing. In order to optimize the quality of the white light generated by the package 10, four LED chips consisting of one red LED chip 16R, two green LED chips 16G, and one blue LED chip 16B, are preferably used in the array 14. It is contemplated, however, that as LED chip design advances, different numbers of LED chips and/or different color LED chips may be used in the linear array 14 to optimize the quality of the white light generated by the LED chip package 10. It is further contemplated that high-power (more than 500 mW per chip) and/or low-power (less than 500 mW per chip) LED chips may be used in the package 10.

In an exemplary embodiment of the present invention, the base 12 may comprise an electrically insulative housing 35, made for example, of plastic or ceramic that encases a metal heat sink 34 with a silicon submount 33 disposed thereon. The metal heat sink 34 provides heat sinking to whatever board the LED package 10 is mounted on. The actual power dissipation of the heat sink 34 may extend to 3 or 4 watts per LED chip, using well-known packaging methods. The base 12 may further include lead wires 37, which are electrically isolated from the metal heat sink 34 and the LED chips 16G, 16R, 16B by the housing 34. Bond wires 36 electrically connect the LED chips 16G, 16R, 16B to the lead wires 37.

The base 12 may be about 22 mm in length L by about 6 mm in width W, and the LED chips 16G, 16R, 16B (the preferred example from above including one red LED chip 16R, two green LED chips 16G, and one blue LED chip 16B) are mounted in a line on 4 mm centers on the base 12. The four LED chips 16G, 16R, 16B in this embodiment are preferably arranged in a green-red-blue-green pattern, wherein the two (identical) green LED chips 16G are disposed at the ends of the linear array 14. This arrangement maximizes the symmetry of the output beam, since the LED chips 16G in the end positions have their light more asymmetrically distorted by the ends of the collimator 18 (the green light is symmetric by construction despite the asymmetries in each of the two chips).

Still referring to FIGS. 1 and 2, the collimator 18 is generally configured as rectangular, horn-like member having a planar top wall 20 that extends parallel to the LED chip mounting surface 13 of the base 12. A pair of side walls 22 depend from the side edges of the planar top wall 20, and converge toward the LED chip mounting surface 13 of the base 12 as shown in FIG. 1. A pair of end walls 24 depend from the end edges of the planar top wall 20 as shown in FIG. 2. The end walls 24 include diverging end wall sections 26 that extend only partially up the height H of the collimator 18 from the LED chip mounting surface 13 of the base 12, and planar end wall sections 28 that extend up the remaining height H of the collimator 18, perpendicular to the planar top wall 20. Each converging or diverging curvature is cylindrical, i.e., the three-dimensional surface is locally defined by translating the two-dimensional parabola or plane.

The collimator 18 is typically manufactured from plastic as a single solid member with a cavity 30 for the LED chips 16G, 16R, 16B. The cavity 30 is typically filled with a transparent silicone material 32. The light emitted by the LED chips 16G, 16R, 16B is reflected from the collimator's side and end walls 22, 24 by total internal reflection, thus, collimating the light and mixing the colors extremely well. Accordingly, the LED chip package 10 of the present invention exhibits greatly improved efficiency and color mixing.

In one illustrative embodiment of the present invention, where the collimator 18 has been optimized for a 6 mm thick backlight waveguide, the side walls 22 are configured to define concave parabolic curves in the y-z plane as seen in FIG. 1, and the diverging end wall sections 26 define convex parabolic curves in the x-z plane as seen in FIG. 2. (This embodiment was developed and tested using the ray-tracing program ASAP™ using a “horn” object that directly allows specification of separate polynomial sections.)

The side walls 22, with their concave parabolic curve configuration, extend to the planar top wall 20 of the collimator 18 to maximize collimation. The diverging end wall sections 26, with their convex parabolic curve configuration, end about 52% of the height H of the collimator 18, where they merge with planar end wall sections 28. This configuration limits very-high-angle emission, i.e., the emission angle defined by roughly the package length L and the height from the base to the cusp at 25 (FIG. 2), while substantially preserving the broad emission pattern of the LED chips 16G, 16R, 16B themselves in the x-z plane, i.e., the LEDs' standard emission pattern minus the light redirected from the very-high-angles. This broad emission pattern in turn facilitates mixing within the light guide (not shown). More specifically, the light is highly collimated in a first direction (y direction) by the side walls 22, which are configured as concave parabolas, while the diverging end wall sections 26, which are configured as convex parabolas, minimally collimate the light in a second direction (x direction) thereby serving to limit only the very high angle rays to a maximum of about 75° from the optical axis z.

In the specific embodiment shown, the parabolic curves in the y-z plane and x-z plane are given, respectively, by the equations (units in mm):

z=1.882y²−2.467y+1.4

x=0.48z²+z+8

with the overall collimator height H (maximum z) being 3.2 mm. The specific values of the coefficients in this embodiment were determined empirically using ASAP. Different parabolas, or even more generally different curves altogether can be used as is found desirable for an effective design.

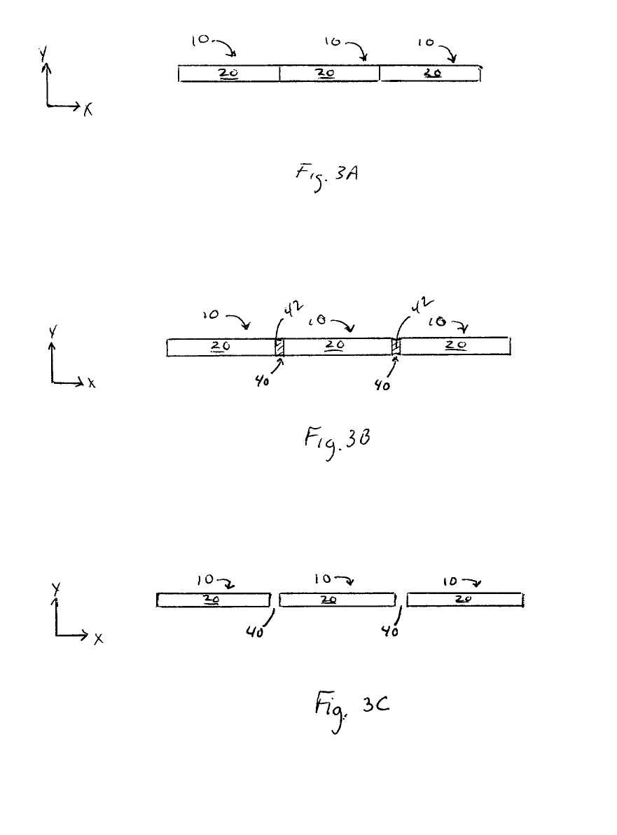

Referring to FIG. 3A, optimal performance is achieved when an array of the LED chip packages 10 of the present invention are arranged so that the end edges of the planar side walls 28 of the collimators 18, which lie in the y-z plane, are in intimate optical contact.

As shown in FIG. 3B, mechanical reasons (such as allowance for thermal expansion), may make it desirable to leave small air gaps 40 between the end edges of the side walls 28 and fill the air gaps 40 with a thick, compliant bonding material 42 such as silicone. For cost reasons, it may be desirable to omit the bonding material and leave the small air gaps 42 as shown in FIG. 3C. This choice does not significantly degrade performance, since the resulting Fresnel reflections at the plastic-air interfaces occur symmetrically about the y-z plane (i.e. from the left and from the right sides). The overall angular distribution pattern is therefore not appreciably altered, nor is there much real loss (i.e. scatter into unfavorable directions).

The LED package 10 of this invention is primarily intended for application in edge lit light guides, which can be used for example in backlighting of LCD displays. The greatest efficiency is obtained when the LED package or the collection of coupled packages (FIGS. 3A-3C) is optically coupled to the material of the light guide.

Although the LED chip package 10 of the present invention is principally intended for LCD backlights applications (all testing was performed in this configuration), the principles of the present invention apply to other applications as well.

While the foregoing invention has been described with reference to the above embodiments, various modifications and changes can be made without departing from the spirit of the invention. Accordingly, such modifications and changes are considered to be within the scope of the appended claims.

What is claimed is:

1. A light-emitting-diode chip package comprising:
a base;
an array of light-emitting-diode chips disposed on the base; and
a collimator mounted on the base, over the array of light-emitting-diode chips.

2. The light-emitting-diode chip package according to claim 1, wherein the lightlight-emitting-diode chips are arranged in the array in an inline manner.

3. The light-emitting-diode chip package according to claim 2, wherein the light-emitting-diode chips at ends of the array emit the same color light.

4. The light-emitting-diode chip package according to claim 2, wherein the light-emitting-diode chips at ends of the array emit green light.

5. The light-emitting-diode chip package according to claim 2, wherein the light-emitting-diode chips include a light-emitting-diode chip that emits blue light, a light-emitting-diode chip that emits green light, and a light-emitting-diode chip that emits red light.

6. The light-emitting-diode chip package according to claim 5, wherein the array of light-emitting-diode chips produce a single unit of white light.

7. The light-emitting-diode chip package according to claim 1, wherein the light-emitting-diode chips include a light-emitting-diode chip that emits blue light, a light-emitting-diode chip that emits green light, and a light-emitting-diode chip that emits red light.

8. The light-emitting-diode chip package according to claim 1, wherein the array of light-emitting-diode chips produces a single unit of white light.

9. The light-emitting-diode chip package according to claim 1, wherein the collimator is generally configured as a rectangular, horn-like member.

10. The light-emitting-diode chip package according to claim 9, wherein the collimator includes a first set of walls that collimate the light emitted by the light-emitting-diode chips in a first direction and a second set of walls that minimally collimate the light emitted by the light-emitting-diode chips in a second direction.

11. The light-emitting-diode chip package according to claim 1, wherein the collimator includes a first set of walls that collimate the light emitted by the light-emitting-diode chips in a first direction and a second set of walls that minimally collimate the light emitted by the light-emitting-diode chips in a second direction.

12. The light-emitting-diode chip package according to claim 1, wherein the base is adapted for bonding lead wires.

13. A light source comprising:
at least two light-emitting-diode chip packages;
each of the light-emitting-diode chip packages including:
a base;
an array of light-emitting-diode chips disposed on the base; and
a collimator mounted on the base, over the array of light-emitting-diode chips.

14. The light source according to claim 13, wherein the light-emitting-diode chips are arranged in each of the arrays in an inline manner.

15. The light source according to claim 13, wherein each of the arrays of light-emitting-diode chips includes a light-emitting-diode chip that emits blue light, a light-emitting-diode chip that emits green light, and a light-emitting-diode chip that emits red light.

16. The light source according to claim 13, wherein each of the arrays of light-emitting-diode chips produces a single unit of white light.

17. The light source according to claim 13, wherein each of the collimators is generally configured as a rectangular, horn-like member.

18. The light source according to claim 13, wherein each of the collimators includes a first set of walls that collimate the light emitted by their respective light-emitting-diode chips in a first direction and a second set of walls that minimally collimate the light emitted by their respective light-emitting-diode chips in a second direction.

19. The light source according to claim 13, wherein each of the bases is adapted for bonding lead wires.
